(19) United States
(12) Patent Application Publication
(10) Pub. No.: US 2025/0218115 A1
(43) Pub. Date: Jul. 3, 2025

(54) MODERATION OF ABUSIVE THREE-DIMENSIONAL AVATARS

(71) Applicant: Roblox Corporation, San Mateo, CA (US)

(72) Inventors: Jessie DUAN, San Mateo, CA (US); Chi Ming WONG, San Mateo, CA (US); David LYU, San Mateo, CA (US); Puneet JAIN, San Mateo, CA (US); Tomo MICHIGAMI, San Mateo, CA (US); Diana ZHANG, San Mateo, CA (US); Ashish MALHOTRA, San Mateo, CA (US)

(73) Assignee: Roblox Corporation, San Mateo, CA (US)

(21) Appl. No.: 18/932,432

(22) Filed: Oct. 30, 2024

Related U.S. Application Data
(60) Provisional application No. 63/615,977, filed on Dec. 29, 2023.

(51) Int. Cl. G06T 17/00; G06V 30/19

(52) U.S. Cl. CPC G06T 17/00; G06V 30/19173

(57) ABSTRACT

A method includes receiving a three-dimensional (3D) avatar. The method further includes generating two-dimensional (2D) images of the 3D avatar from different angles that surround the 3D avatar. The method further includes providing the 2D images as input to a trained machine-learning model. The method further includes generating, with the machine-learning model, a concatenated embedding of the 2D images. The method further includes analyzing, with the machine-learning model based on the concatenated embedding, at least one attribute associated with the 3D avatar, wherein the at least one attribute is selected from a group of a shape of the 3D avatar, an outfit on the 3D avatar, and combinations thereof. The method further includes outputting, with the machine-learning model, a determination that the at least one attribute of the 3D avatar is abusive.

### CROSS-REFERENCE TO RELATED APPLICATIONS

This application claims priority under 35 U.S.C. §119(e) to U.S. Provisional Patent Application No. 63/615,977, filed on Dec. 29, 2023 and titled DETECTING ABUSIVE TEXT ON THREE-DIMENSIONAL AVATARS, the contents of which are hereby incorporated by reference herein in its entirety.

### BACKGROUND

Abuse in a virtual environment occurs in multiple ways. For example, avatars may wear offensive outfits, players may perform offensive actions, players may say offensive things, and players may type offensive words into a group chat. Detecting abuse, such as abusive text on the avatar's body or outfits, is difficult because the sheer volume of user-generated content in virtual worlds can be enormous, making it difficult to manually review and moderate everything in real-time. Additionally, the avatars can change outfits or appearance rapidly, requiring continuous monitoring. The longer the delay between a violation and a consequence, the more likely that a player will continue to commit abuse in the virtual environment.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A method includes receiving a three-dimensional (3D) avatar. The method further includes generating two-dimensional (2D) images of the 3D avatar from different angles that surround the 3D avatar. The method further includes providing the 2D images as input to a trained machine-learning model. The method further includes generating, with the machine-learning model, a concatenated embedding of the 2D images. The method further includes analyzing, with the machine-learning model based on the concatenated embedding, at least one attribute associated with the 3D avatar, wherein the at least one attribute is selected from a group of a shape of the 3D avatar, an outfit on the 3D avatar, and combinations thereof. The method further includes outputting, with the machine-learning model, a determination that the at least one attribute of the 3D avatar is abusive.

In some embodiments, the method further includes detecting text on one or more of the 2D images of the 3D avatar; extracting the text from the one or more of the 2D images; and classifying the extracted text to determine if the extracted text is abusive, wherein the determination that the attribute is abusive is based on classifying the extracted text as abusive. In some embodiments, the 3D avatar is generated by a user and the method further comprises responsive to outputting the determination, providing a notification to the user that the 3D avatar includes the attribute that is abusive and one or more of an identification of a category of abuse, a severity of abusiveness of the attribute, a reason that the attribute is abusive, and combinations thereof. In some embodiments, the method further includes receiving, from the user, an updated 3D avatar; generating updated 2D images of the updated 3D avatar from different angles that surround the updated 3D avatar; providing the updated 2D images as input to the machine-learning model; outputting, with the machine-learning model, a determination that the attributes are acceptable; and providing the user with an option to use the updated 3D avatar in a virtual environment. In some embodiments, the machine-learning model is trained using training data and the method further includes responsive to the updated 3D avatar being used in the virtual environment, receiving an abuse report from a player in the virtual environment that describes the updated 3D avatar as having an abusive attribute; determining that the updated 3D avatar has the abusive attribute; and updating the training data associated with the machine-learning model to include the updated 2D images and a label with the category of abuse.

In some embodiments, wherein the machine-learning model includes a Convolutional Neural Network (CNN) that generates the concatenated embedding of the 2D images by extracting, with a pooling layer, a respective view embedding for each of the 2D images; and concatenating the view embeddings to form the concatenated embedding. In some embodiments, the machine-learning model is trained using synthetic training data for text and the synthetic training data is generated by identifying a category of abuse for text where the determination that the attribute is abusive is associated with a confidence score that falls below a threshold confidence value; generating abusive text that is associated with the identified category; generating a training 3D avatar; projecting the abusive text onto the training 3D avatar; generating training 2D images from the training 3D avatar with the projected abusive text; applying a label to the training 2D images that includes the category of abuse; and training the machine-learning model to minimize a difference between a predicted category of abuse for the training 2D images and the label for the training 2D images. In some embodiments, the synthetic training data is further generated by shuffling the training 2D images and augmenting the training 2D images with random color jittering. In some embodiments, the machine-learning model is trained using training data and the method further includes updating the training data associated with the machine-learning model to include training images of attributes that are recently determined to be abusive. In some embodiments, generating the 2D images of the 3D avatar includes capturing high-resolution thumbnails using a virtual camera system.

A non-transitory computer-readable medium with instructions that, when executed by one or more processors at a client device, cause the one or more processors to perform operations. The operations comprise receiving a 3D avatar; generating 2D images of the 3D avatar from different angles that surround the 3D avatar; providing the 2D images as input to a trained machine-learning model; generating, with the machine-learning model, a concatenated embedding of the 2D images; analyzing, with the machine-learning model based on the concatenated embedding, at least one attribute associated with the 3D avatar, wherein the at least one attribute is selected from a group of a shape of the 3D avatar, an outfit on the 3D avatar, and combinations thereof; and outputting, with the machine-learning model, a determination that the at least one attribute of the 3D avatar is abusive.

In some embodiments, the operations further include detecting text on one or more of the 2D images of the 3D avatar; extracting the text from the one or more of the 2D images; and classifying the extracted text to determine if the extracted text is abusive, wherein the determination that the attribute is abusive is based on classifying the extracted text as abusive. In some embodiments, the 3D avatar is generated by a user and the operations further include responsive to outputting the determination, providing a notification to the user that the 3D avatar includes the attribute that is abusive and one or more of an identification of a category of abuse, a severity of abusiveness of the attribute, a reason that the attribute is abusive, and combinations thereof. In some embodiments, the operations further include receiving, from the user, an updated 3D avatar; generating updated 2D images of the updated 3D avatar from different angles that surround the updated 3D avatar; providing the updated 2D images as input to the machine-learning model; outputting, with the machine-learning model, a determination that the attributes are acceptable; and providing the user with an option to use the updated 3D avatar in a virtual environment. In some embodiments, the machine-learning model is trained using training data and the operations further include responsive to the updated 3D avatar being used in the virtual environment, receiving an abuse report from a player in the virtual environment that describes the updated 3D avatar as having an abusive attribute; determining that the updated 3D avatar has the abusive attribute; and updating the training data associated with the machine-learning model to include the updated 2D images and a label with the category of abuse.

A system comprises a processor; and a memory coupled to the processor, with instructions stored thereon that, when executed by the processor, cause the processor to perform operations. The operations comprise receiving a 3D avatar; generating 2D images of the 3D avatar from different angles that surround the 3D avatar; providing the 2D images as input to a trained machine-learning model; generating, with the machine-learning model, a concatenated embedding of the 2D images; analyzing, with the machine-learning model based on the concatenated embedding, at least one attribute associated with the 3D avatar, wherein the at least one attribute is selected from a group of a shape of the 3D avatar, an outfit on the 3D avatar, and combinations thereof; and outputting, with the machine-learning model, a determination that the at least one attribute of the 3D avatar is abusive.

In some embodiments, the operations further include detecting text on one or more of the 2D images of the 3D avatar; extracting the text from the one or more of the 2D images; and classifying the extracted text to determine if the extracted text is abusive, wherein the determination that the attribute is abusive is based on classifying the extracted text as abusive. In some embodiments, the 3D avatar is generated by a user and the operations further include responsive to outputting the determination, providing a notification to the user that the 3D avatar includes the attribute that is abusive and one or more of an identification of a category of abuse, a severity of abusiveness of the attribute, a reason that the attribute is abusive, and combinations thereof. In some embodiments, the operations further include receiving, from the user, an updated 3D avatar; generating updated 2D images of the updated 3D avatar from different angles that surround the updated 3D avatar; providing the updated 2D images as input to the machine-learning model; outputting, with the machine-learning model, a determination that the attributes are acceptable; and providing the user with an option to use the updated 3D avatar in a virtual environment. In some embodiments, the machine-learning model is trained using training data and the operations further include responsive to the updated 3D avatar being used in the virtual environment, receiving an abuse report from a player in the virtual environment that describes the updated 3D avatar as having an abusive attribute; determining that the updated 3D avatar has the abusive attribute; and updating the training data associated with the machine-learning model to include the updated 2D images and a label with the category of abuse.

### BRIEF DESCRIPTION OF THE DRAWINGS

FIG. 1 is a block diagram of an example network environment, according to some embodiments described herein.

FIG. 2A is a block diagram of an example computing device, according to some embodiments described herein.

FIG. 2B is a block diagram of an example machine-learning module, according to some embodiments described herein.

FIG. 3 is an example illustration of the process for creating synthetic training data, according to some embodiments described herein.

FIG. 4 is an example of the process for creating two-dimensional images of a three-dimensional avatar, according to some embodiments described herein.

FIG. 5 is an example of the process of classifying text on an avatar, according to some embodiments described herein.

FIG. 6 is an example of example outputs from a machine-learning model that classifies text, according to some embodiments described herein.

FIG. 7 is an example multiview fusion model, according to some embodiments described herein.

FIG. 8 illustrates an example user interface that warns the user that the abusive avatar generated during avatar creation may result in a remedial action, according to some embodiments described herein.

FIG. 9 is a flowchart of an example method to generate synthetic training data for a machine-learning model, according to some embodiments described herein.

FIG. 10 is a flowchart of an example method to train a machine-learning model to identify an abusive avatar, according to some embodiments described herein.

FIG. 11 is a flowchart of an example method to moderate avatars, according to some embodiments described herein.

### DETAILED DESCRIPTION

### Overview

Detecting abusive avatars in real-time in a virtual environment is difficult because of the inherent delay present in waiting for a moderator to review three-dimensional (3D) avatars for violations. Designing machine-learning models to identify abusive 3D avatars for a virtual experience has been difficult because if the machine-learning models output too many false positives (i.e., identifies too many instances of abuse that are not actually abuse), then it annoys users and discourages them from creating avatars for a virtual environment. Conversely, if the machine-learning models output too many false negatives (i.e., fails to identify instances of abuse), it risks an unsafe virtual experience where too many users are exposed to abuse.

One way in which machine-learning models fail to identify abusive 3D avatars is by reviewing two-dimensional (2D) images of 3D avatars in isolation. This results in too many false negatives because a flat image may look acceptable when a violation would be identifiable on the 3D avatar. For example, an avatar with a sexually suggestive shape may not be identifiable when viewing the avatar straight on but could be discernable from side angles.

The technology described below advantageously describes using a moderation application that includes a machine-learning model to output a determination of whether a 3D avatar is abusive that determines abusiveness based on text, shape, and outfit. The moderation application generates multiple 2D images of the 3D avatar from different angles that surround the 3D avatar.

The moderation application determines whether the 3D avatar includes abusive text by performing text detection on each of the 2D images. Responsive to detecting text on a 2D image, the text is extracted. The extracted text is classified to determine if the extracted text is abusive. This advantageously ensures that abusive text is detected even when the text is less obvious, such as text that is located on the side of an avatar's torso or warped based on the fit of clothing.

The moderation application provides the 2D images to a machine-learning model, such as a Convolutional Neural Network (CNN) that extracts respective view embeddings that correspond to each of the multiple 2D images and that concatenates the view embeddings to form a concatenated embedding, which is fed to a MultiLayer Perceptron (MLP) that outputs a determination of whether the 3D avatar is abusive. The MLP may be trained to recognize different abusive shapes or abusive outfits. In some embodiments, the concatenated embedding is provided to two different MLPs that are trained to identify abusive shapes or abusive outfits, respectively.

In some embodiments, the moderation application is used each time a user creates a 3D avatar, creates an outfit for the 3D avatar, in response to a player submitting an abuse report, etc. As a result of improving the accuracy of the moderation application, the virtual experience is a safe and enjoyable experience for players.

### Example Network Environment

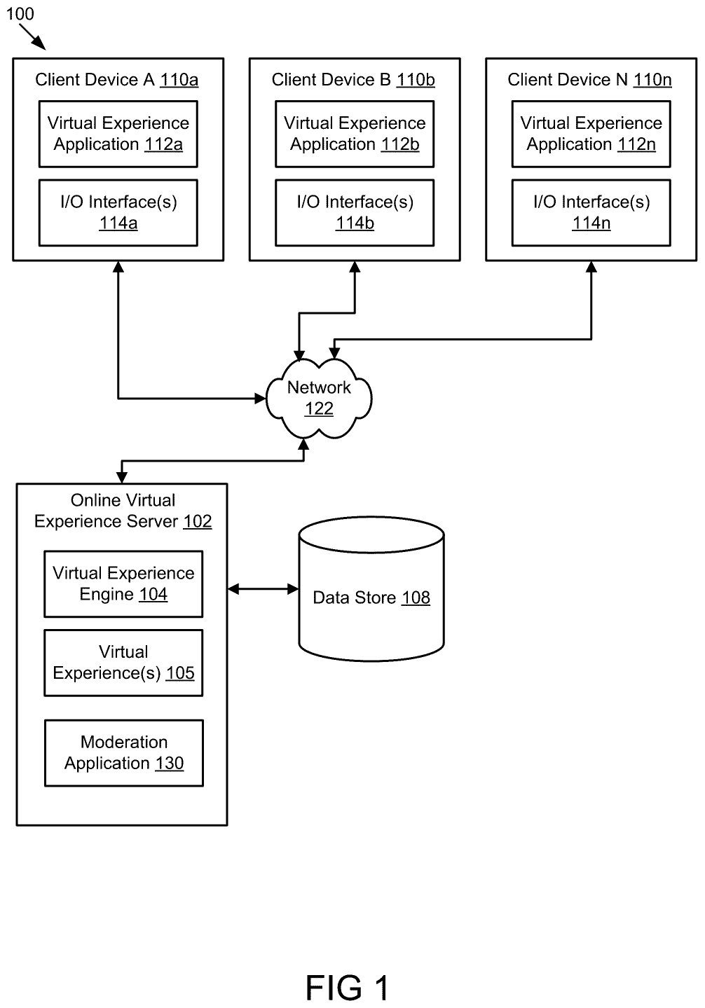

FIG. 1 illustrates an example network environment 100, in accordance with some implementations of the disclosure. FIG. 1 and the other figures use like reference numerals to identify like elements. A letter after a reference numeral, such as “110a,” indicates that the text refers specifically to the element having that particular reference numeral. A reference numeral in the text without a following letter, such as “110,” refers to any or all of the elements in the figures bearing that reference numeral (e.g., “110” in the text refers to reference numerals “110a,” “110b,” and/or “110n” in the figures).

The network environment 100 (also referred to as a “platform” herein) includes an online virtual experience server 102, a data store 108, and a client device 110 (or multiple client devices), all connected via a network 122.

The online virtual experience server 102 can include, among other things, a virtual experience engine 104, one or more virtual experiences 105, and a moderation application 130. The online virtual experience server 102 may be configured to provide virtual experiences 105 to one or more client devices 110, and to moderate three-dimensional (3D) avatars via the moderation application 130, in some implementations.

Data store 108 is shown coupled to online virtual experience server 102 but in some implementations, can also be provided as part of the online virtual experience server 102. The data store may, in some implementations, be configured to store advertising data, user data, engagement data, and/or other contextual data in association with the moderation application 130.

The client devices 110 (e.g., 110a, 110b, 110n) can include a virtual experience application 112 (e.g., 112a, 112b, 112n) and an I/O interface 114 (e.g., 114a, 114b, 114n), to interact with the online virtual experience server 102, and to view, for example, graphical user interfaces (GUI) through a computer monitor or display (not illustrated). In some implementations, the client devices 110 may be configured to execute and display virtual experiences, which may include virtual user engagement portals as described herein.

Network environment 100 is provided for illustration. In some implementations, the network environment 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a Long Term Evolution (LTE) network), routers, hubs, switches, server computers, or a combination thereof.

In some implementations, the data store 108 may be a non-transitory computer readable memory (e.g., random access memory), a cache, a drive (e.g., a hard drive), a flash drive, a database system, or another type of component or device capable of storing data. The data store 108 may also include multiple storage components (e.g., multiple drives or multiple databases) that may also span multiple computing devices (e.g., multiple server computers).

In some implementations, the online virtual experience server 102 can include a server having one or more computing devices (e.g., a cloud computing system, a rackmount server, a server computer, cluster of physical servers, virtual server, etc.). In some implementations, a server may be included in the online virtual experience server 102, be an independent system, or be part of another system or platform. In some implementations, the online virtual experience server 102 may be a single server, or any combination a plurality of servers, load balancers, network devices, and other components. The online virtual experience server 102 may also be implemented on physical servers, but may utilize virtualization technology, in some implementations. Other variations of the online virtual experience server 102 are also applicable.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user (e.g., user 114 via client device 110) with access to online virtual experience server 102.

The online virtual experience server 102 may also include a website (e.g., one or more web pages) or application back-end software that may be used to provide a user with access to content provided by online virtual experience server 102. For example, users (or developers) may access online virtual experience server 102 using the virtual experience application 112 on client device 110, respectively.

In some implementations, online virtual experience server 102 may include digital asset and digital virtual experience generation provisions. For example, the platform may provide administrator interfaces allowing the design, modification, unique tailoring for individuals, and other modification functions. In some implementations, virtual experiences may include two-dimensional (2D) games, three-dimensional (3D) games, virtual reality (VR) games, or augmented reality (AR) games, for example. In some implementations, virtual experience creators and/or developers may search for virtual experiences, combine portions of virtual experiences, tailor virtual experiences for particular activities (e.g., group virtual experiences), and other features provided through the virtual experience server 102.

In some implementations, online virtual experience server 102 or client device 110 may include the virtual experience engine 104 or virtual experience application 112. In some implementations, virtual experience engine 104 may be used for the development or execution of virtual experiences 105. For example, virtual experience engine 104 may include a rendering engine (“renderer”) for 2D, 3D, VR, or AR graphics, a physics engine, a collision detection engine (and collision response), sound engine, scripting functionality, haptics engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.).

The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110 (not illustrated). In some implementations, each virtual experience 105 may have a different ratio between the virtual experience engine functions that are performed on the online virtual experience server 102 and the virtual experience engine functions that are performed on the client device 110.

In some implementations, virtual experience instructions may refer to instructions that allow a client device 110 to render gameplay, graphics, and other features of a virtual experience. The instructions may include one or more of user input (e.g., physical object positioning), character position and velocity information, or commands (e.g., physics commands, rendering commands, collision commands, etc.).

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may also be referred to as a “client device 110.” In some implementations, one or more client devices 110 may connect to the online virtual experience server 102 at any given moment. It may be noted that the number of client devices 110 is provided as illustration, rather than limitation. In some implementations, any number of client devices 110 may be used.

In some implementations, each client device 110 may include an instance of the virtual experience application 112. The virtual experience application 112 may be rendered for interaction at the client device 110. During user interaction within a virtual experience or another GUI of the online platform 100, a user may create an avatar that includes different body parts from different libraries. The moderation application 130 may receive a 3D avatar, generate two-dimensional (2D) images of the 3D avatar from different angles that surround the 3D avatar, and determine that at least one attribute of the 3D avatar is abusive.

### Example Computing Device

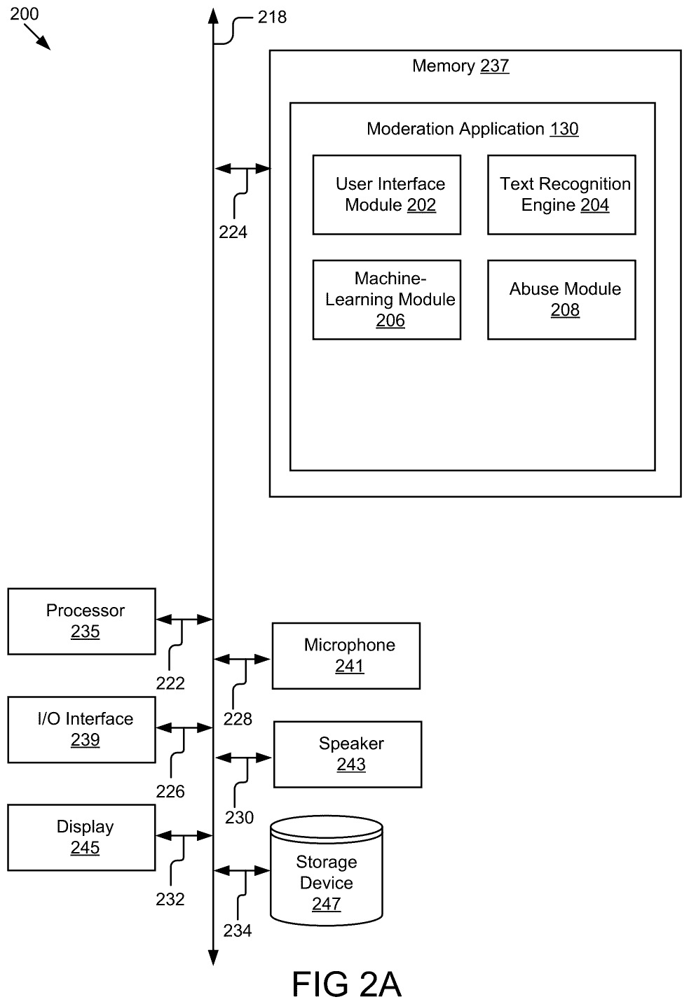

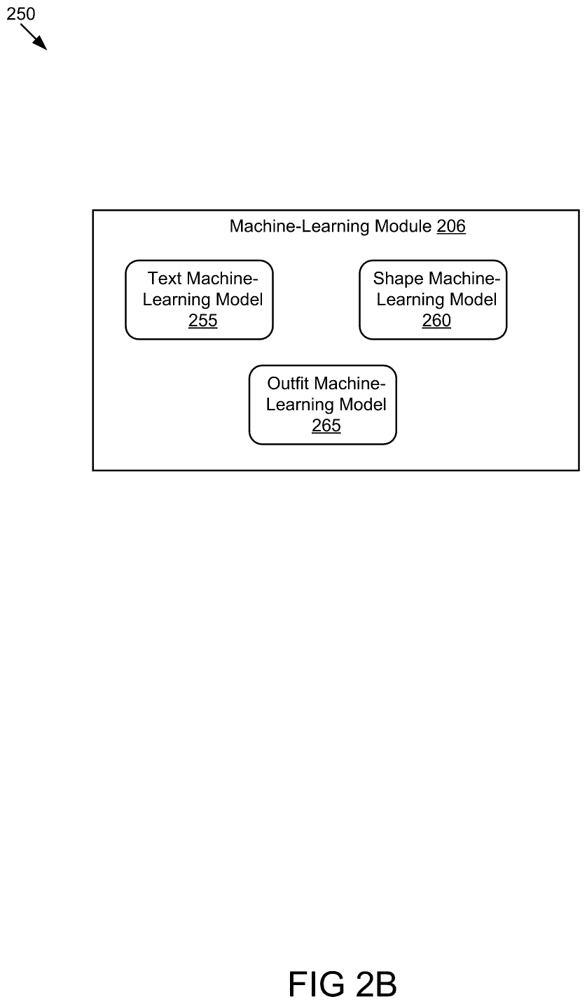

FIG. 2A is a block diagram of an example computing device 200 that may be used to implement one or more features described herein. Computing device 200 can be any suitable computer system, server, or other electronic or hardware device. In some embodiments, the computing device 200 is the client device 110. In some embodiments, the computing device 200 is the online virtual experiences server 102.

In some embodiments, computing device 200 includes a processor 235, a memory 237, an Input/Output (I/O) interface 239, a microphone 241, a speaker 243, a display 245, and a storage device 247, all coupled via a bus 218. In some embodiments, the computing device 200 includes additional components not illustrated in FIG. 2A. In some embodiments, the computing device 200 includes fewer components than are illustrated in FIG. 2A. For example, in instances where the moderation application 130 is stored on the online virtual experiences server 102 in FIG. 1, the computing device may not include a microphone 241, a speaker 243, or a display 245.

The processor 235 may be coupled to a bus 218 via signal line 222, the memory 237 may be coupled to the bus 218 via signal line 224, the I/O interface 239 may be coupled to the bus 218 via signal line 226, the microphone 241 may be coupled to the bus 218 via signal line 228, the speaker 243 may be coupled to the bus 218 via signal line 230, the display 245 may be coupled to the bus 218 via signal line 232, and the storage device 247 may be coupled to the bus 218 via signal line 234.

The processor 235 includes an arithmetic logic unit, a microprocessor, a general-purpose controller, or some other processor array to perform computations and provide instructions to a display device. Processor 235 processes data and may include various computing architectures including a complex instruction set computer (CISC) architecture, a reduced instruction set computer (RISC) architecture, or an architecture implementing a combination of instruction sets. In some implementations, the processor 235 may include special-purpose units, e.g., machine learning processor, audio/video encoding and decoding processor, etc. Although FIG. 2A illustrates a single processor 235, multiple processors 235 may be included. In different embodiments, processor 235 may be a single-core processor or a multicore processor. Other processors (e.g., graphics processing units), operating systems, sensors, displays, and/or physical configurations may be part of the computing device 200, such as a keyboard, mouse, etc.

The memory 237 stores instructions that may be executed by the processor 235 and/or data. The instructions may include code and/or routines for performing the techniques described herein. The memory 237 may be a dynamic random-access memory (DRAM) device, a static RAM, or some other memory device. In some embodiments, the memory 237 also includes a non-volatile memory, such as a static random access memory (SRAM) device or flash memory, or similar permanent storage device and media including a hard disk drive, a compact disc read only memory (CD-ROM) device, a DVD-ROM device, a DVD-RAM device, a DVD-RW device, a flash memory device, or some other mass storage device for storing information on a more permanent basis. The memory 237 includes code and routines operable to execute the moderation application 130, which is described in greater detail below.

I/O interface 239 can provide functions to enable interfacing the computing device 200 with other systems and devices. Interfaced devices can be included as part of the computing device 200 or can be separate and communicate with the computing device 200. For example, network communication devices, storage devices (e.g., memory 237 and/or storage device 247), and input/output devices can communicate via I/O interface 239. In another example, the I/O interface 239 can receive data from the online virtual experiences server 102 and deliver the data to the moderation application 130 and components of the moderation application 130, such as the user interface module 202. In some embodiments, the I/O interface 239 can connect to interface devices such as input devices (keyboard, pointing device, touchscreen, microphone 241, sensors, etc.) and/or output devices (display 245, speaker 243, etc.).

Some examples of interfaced devices that can connect to I/O interface 239 can include a display 245 that can be used to display content, e.g., images, video, and/or a user interface of the metaverse as described herein, and to receive touch (or gesture) input from a user. Display 245 can include any suitable display device such as a liquid crystal display (LCD), light emitting diode (LED), or plasma display screen, cathode ray tube (CRT), television, monitor, touchscreen, three-dimensional display screen, a projector (e.g., a 3D projector), or other visual display device.

The microphone 241 includes hardware, e.g., one or more microphones that detect audio spoken by a person. The microphone 241 may transmit the audio to the moderation application 130 via the I/O interface 239.

The speaker 243 includes hardware for generating audio for playback. In some embodiments, the speaker 243 may include audio hardware that supports playback via an external, separate speaker (e.g., wired or wireless headphones, external speakers, or other audio playback device) that is coupled to the computing device 200.

The storage device 247 stores data related to the moderation application 130. For example, the storage device 247 may store a user profile associated with a user 125, a list of blocked avatars, training data, embeddings from a machine-learning model, etc.

### Example Moderation Application

FIG. 2A illustrates a computing device 200 that executes an example moderation application 130 that includes a user interface module 202, a text recognition engine 204, a machine-learning module 206, and an abuse module 208. In some embodiments, a single computing device 200 includes all the components illustrated in FIG. 2A. In some embodiments, one or more of the components may be on different computing devices 200. For example, the client device 110 may include the user interface module 202, while the text recognition engine 204, the machine-learning module 206, and the abuse module 208 are implemented on the online virtual experiences server 102. In some embodiments, different portions of one or more of modules 202, 204, 206, and 208 may be implemented on the client device 110 and on the online virtual experiences server 102. For example, the machine-learning module 206 may reside on the online virtual experiences server 102 to reduce security risks that are present with the machine-learning module 206 residing on the client device 110.

The user interface module 202 generates graphical data for displaying a user interface for users associated with client devices 110 to participate in a virtual experience. In some embodiments, before a user participates in the virtual experience, the user interface module 202 generates a user interface that includes information about how the user's information may be collected, stored, and/or analyzed. For example, the user interface requires the user to provide permission to use any information associated with the user. The user is informed that the user information may be deleted by the user, and the user may have the option to choose what types of information are provided for different uses. The use of the information is in accordance with applicable regulations and the data is stored securely. Data collection is not performed in certain locations and for certain user categories (e.g., based on age or other demographics), the data collection is temporary (i.e., the data is discarded after a period of time), and the data is not shared with third parties. Some of the data may be anonymized, aggregated across users, or otherwise modified so that specific user identity cannot be determined.

The user interface module 202 generates graphical data for displaying a user interface for designing a 3D avatar to be used in the virtual experience. The user interface includes options for selecting a type of character (e.g., human, humanoid, non-human, etc.) and selecting attributes of the character, including sex, height, shape, clothing, etc. The user interface includes an option for adding text to 3D avatar by adding text to clothing, to skin, designing a tattoo for the 3D avatar that includes text, etc. The user interface includes options for rotating the 3D avatar and placing text or other attributes on different parts of the avatar's body.

In some embodiments, once a user has completed design of the 3D avatar, the user may finalize the 3D avatar and request to save the avatar in a user account associated with the user. In some embodiments, the user interface module 202 generates 2D images of the 3D avatar from different angles that surround the 3D avatar. In the examples described below, the user interface module 202 generates eight 2D images of the 3D avatar, but any number of 2D images may be generated. The text recognition engine 204 determines whether the 3D avatar includes text and, if so, extracts the text. The machine-learning module 206 determines whether extracted text and/or other attributes (e.g., shape and outfit) are abusive. In some embodiments, the 3D avatar is analyzed for attributes that are abusive in a two-stage process where first the body of the 3D avatar is analyzed and second any outfits created for the 3D avatar are analyzed.

Responsive to a determination that any of the attributes are abusive, the user interface module 202 provides a notification to the user. The notification includes that the attribute is abusive and may include an identification of a category of abuse (e.g., attributes associated with a hate group, nudity, suggestive; text that is profane, racist, sexist, bullying, etc.), a severity of abusiveness (e.g., mild, medium, high), and/or a reason that the attribute is abusive (e.g., the 3D avatar has visible genitals). In some embodiments, the notification may include a warning. In some embodiments, the abuse module 208 may impose a remedial action, such as if the user is associated with reports of abuse, a history of abusive behavior, based on the severity of the abusiveness, etc.

In some embodiments, the notification includes an option to appeal a determination of abuse. The user interface module 202 may provide the 2D images of the 3D avatar to one or more moderators that may confirm the determination of abuse or overrule the determination of abuse.

The user may generate an updated 3D avatar and resubmit the updated 3D avatar for approval. If the updated 3D avatar has acceptable attributes, the user interface module 202 may notify the user that the updated 3D avatar can be saved to the user account associated with the user and may be used in a virtual experience 105.

The user interface module 202 receives user input from a user during gameplay of a virtual experience 105. For example, the user input may cause an avatar to move around, perform actions, change poses, speak to other users, etc. in the virtual experience. The user interface module 202 generates graphical data for displaying the location, actions, poses, etc. of the avatar within the virtual experience 105.

The user may interact with other users in the virtual experience. Some of these interactions may be negative and, in some embodiments, the user interface module 202 generates graphical data for a user interface that enables a user to limit exposure to other users that the user wants to avoid. For example, the user interface module 202 may include an option to mute other users, block other users, and report abuse that occurs in the virtual experience. For example, another avatar may be wearing an objectionable piece of clothing (e.g., a T-shirt or a hat), an avatar may be holding an inappropriate object (e.g., a flag associated with a hate group, an object in the shape of something offensive, etc.), an avatar may perform an offensive action (e.g., the avatar may use spray paint to draw an image of genitals), or an avatar may utter an inappropriate phrase (e.g., either in a chat box or directly via voice chat to the user). One avatar may also be associated with multiple types of abuse, such as wearing inappropriate clothing while performing an offensive act.

The text recognition engine 204 detects text on one or more of the 2D images generated from the 3D avatar by the user interface module 202. The text may be digital text, handwritten, contain different fonts, styles, strokes, colors, etc. and be in any language. Responsive to the text recognition engine 204 detecting the text, the text recognition engine 204 extracts the text. In some embodiments, the text recognition engine 204 uses Optical Character Recognition (OCR) to classify the text.

The machine-learning module 206 trains a machine-learning model to output a determination of whether at least one attribute of a 3D avatar is abusive. In some embodiments, the machine-learning module 206 includes different machine-learning models that are trained for different functions. For example, FIG. 2B is a block diagram 250 of an example machine-learning module 206 that includes three different machine-learning models: a text machine- learning model 255 that determines whether text is abusive, a shape machine-learning model 260 that determines whether a shape is abusive, and an outfit machine-learning model 265 that determines whether an outfit is abusive. In some embodiments, the machine-learning module 206 trains the text machine-learning model 255, the shape machine-learning model 260, and/or the outfit machine-learning model 265 using a cross-entropy loss function. In some embodiments, before a machine-learning model is trained on 3D avatars, the 3D avatars are filtered to remove duplicates (or similar types of avatars) to avoid overtraining the machine-learning model on particular types of 3D avatars.

In some embodiments, the machine-learning module 206 trains the text machine-learning model 255 to detect and classify offensive keywords and/or offensive phrases. The machine-learning module 206 trains the text machine-learning model using a training data set. In some embodiments, the training data set includes both abusive and non-abusive words. In some embodiments, the training data set also includes ground truth labeled data. The ground truth labeled data may be generated when moderators review labels assigned by the text machine-learning model 255 and confirm or modify the labels. The labels may include both an identification of whether text is abusive or non-abusive, as well as categories of abuse, such as profanity, racism, sexism, bullying, etc. In some embodiments, the ground truth labels may also be derived from abuse reports where a user complains about another user's behavior and a moderator verifies that the text is abusive and applies labels to the text submitted with the abuse report.

In some embodiments, the machine-learning module 206 generates synthetic data sets to supplement the training data set. For example, the machine-learning module 206 may identify a category of abuse for text where there are insufficient examples and/or where the text machine- learning model provides unreliable results. In some embodiments, the machine-learning module 206 generates synthetic data for categories where a determination that the attribute is abusive is associated with a confidence score that falls below a threshold confidence value.

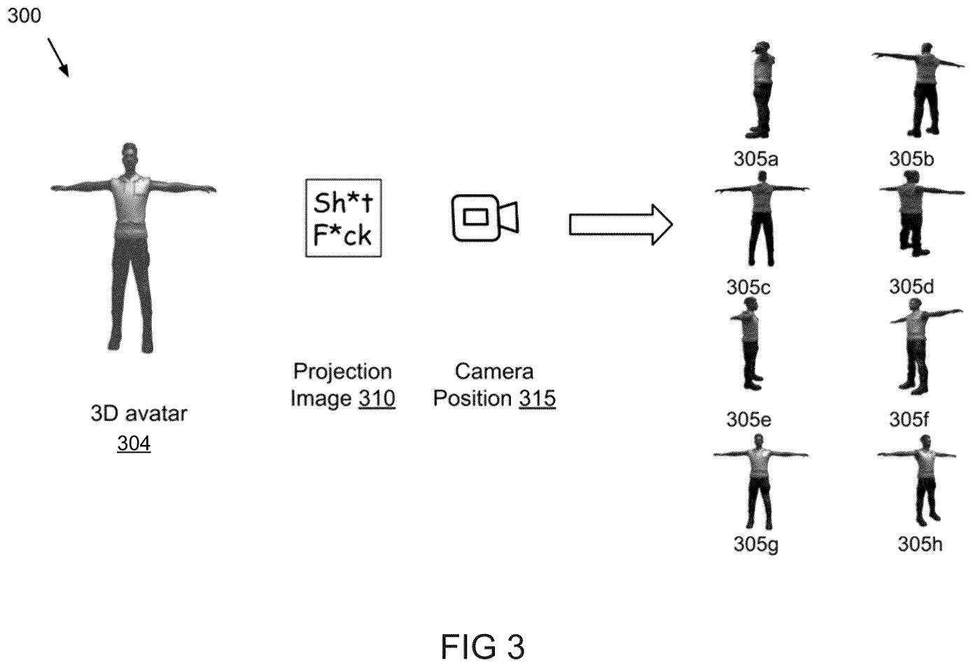

Turning to FIG. 3, an example 300 of the process for creating synthetic training data is illustrated, according to some embodiments described herein. The machine-learning module 206 selects 3D avatars 304. In some embodiments, 3D avatars 304 are identified in a virtual experience. The 3D avatars 304 can be human-like, realistic cartoon characters, abstract figures, etc. The 3D avatars 304 can be naked, wearing an outfit (e.g., shirt, pants, etc.), wearing an accessory (e.g., a cap), or having a tattoo. The machine-learning module 206 identifies a 3D mesh of the 3D avatar 304 in a virtual experience and separates the 3D avatar 304 from the surrounding scene.

The machine-learning module 206 receives a set of images containing representative text samples. The text can be handwritten; digital; contain a varying number of fonts, styles, strokes, colors; include in different languages, etc. The text machine-learning model 255 can be trained on abusive text (e.g., “F*ck, wh*re, sex) and non-abusive text (e.g., chill, hello, world).

The machine-learning module 206 utilizes depth information available in 3D environments to isolate text from the background. The isolated text is then projected on top of the 3D avatar 304, at different angles and orientations, using a virtual camera system. For example, the 3D avatar 304 is combined with a projection image 310. The 3D avatar with the projected image 310 is then captured at different virtual camera positions 315 to generate multiple 2D images 305a-305h of the 3D avatar 304 that include the projected image. In some embodiments, the machine-learning module 206 identifies particular distances and camera angles so that text is projected consistently on the 3D avatar 304. In some embodiments, instead of capturing discrete images at different angles, the camera system captures a video of the 3D avatar 304 with the projected text by moving around the 3D avatar 304. The 2D images 305 are created from a variety of different types of avatars in order to synthesize a diverse set of examples of how text is different depending on avatars that are tall or short, smooth or rippled, straight or spherical, etc.

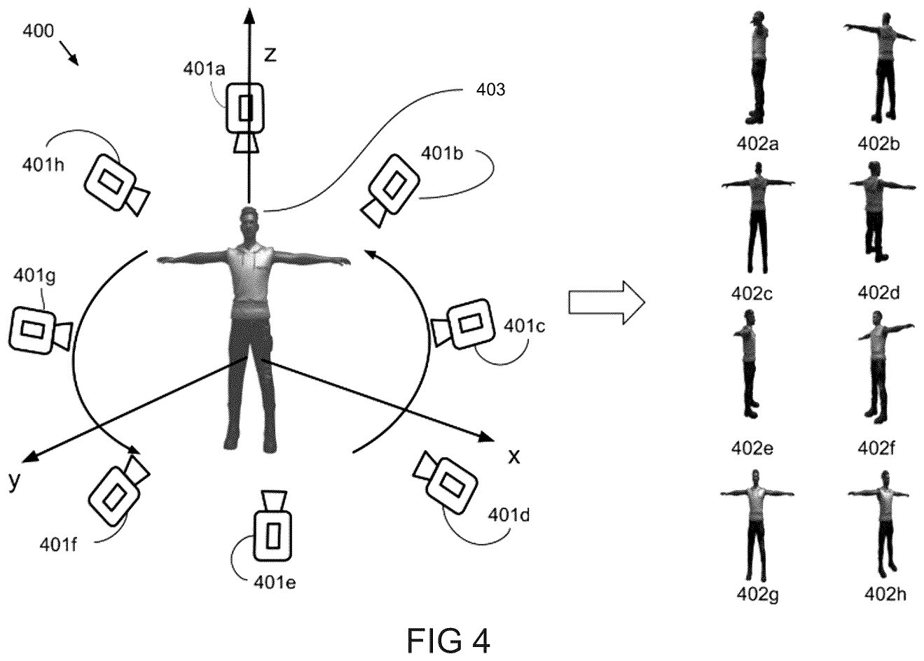

Turning to FIG. 4, an example of the process 400 for creating 2D images 402 of a 3D avatar 403 is illustrated, according to some embodiments described herein. The input 3D avatar 403 may be human, humanoid, or non-human and may take the form of realistic cartoon characters, abstract figures, etc. The 3D avatars 403 may be naked or wearing an outfit (e.g., shirt, pants, cap, etc.).

In this example, multiple high-resolution images of the 3D avatar 403 are captured from different angles, for example, using a virtual camera system 401a-401h. In some embodiments, the virtual camera system 401 is positioned in the virtual 3D space to capture the 3D avatar 403 from specific viewpoints. The virtual camera system 401 adjusts the camera parameters such as field of view, focal length, and depth of field to control the final composition. The virtual camera system 401 generates multiple 2D images 402a-402h of the 3D avatar. Each 2D image 402 is captured from a different angle or orientation by the virtual camera system 401. The 2D images 402 are preprocessed to enhance the quality and make them suitable for text detection, such as by resizing, cropping, and adjusting the brightness and contrast of the 2D images 402. In some embodiments, the 2D images 402 are saved as high-resolution thumbnails.

In some embodiments, the machine-learning module 206 employs the process 400 in FIG. 4 to generate synthetic training data for different types of attributes. For example, the machine-learning module 206 may generate synthetic training data for different categories of abusive outfits and different categories of abusive shapes of 3D avatars. In some embodiments, a user manually creates the different 3D avatars and uses the process 400 in FIG. 4 to generate the synthetic training data. For example, a user may manually create a 3D avatar with exaggerated shapes for different examples of inappropriate body shapes. In another example, a user may create a 3D avatar with varying amounts of clothing (also referred to as modesty layers) for different body shapes (e.g., a modesty layer that does not sufficiently cover cleavage is labeled as abusive for violating nudity standards).

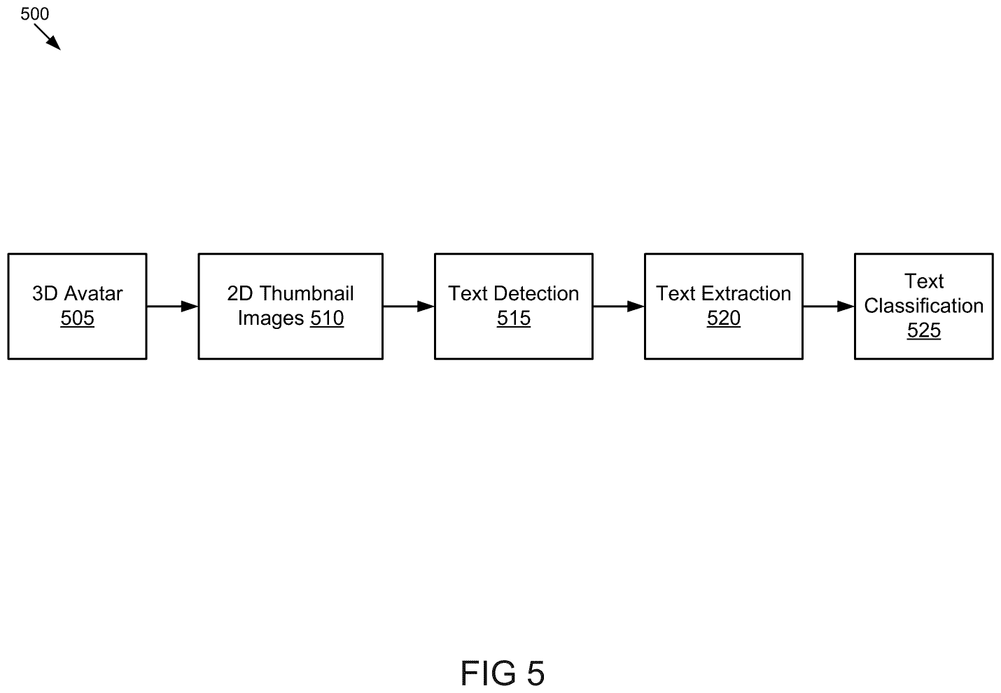

Turning to FIG. 5, an example process 500 for classifying text on an avatar is illustrated. In some embodiments, the user interface 202 generates 2D thumbnail images 510 of the 3D avatar 505. For example, the user interface module 202 may include a camera system that captures multiple 2D thumbnail images 510 of the 3D avatar 505. The 2D thumbnail images 510 of the 3D avatar 505 are captured from multiple angles and from different orientations with a virtual camera system that surrounds the 3D avatar.

The text recognition engine 204 receives the 2D thumbnail images 510 and performs text detection 515. The text recognition engine 204 identifies regions in the images that potentially contain text. In some embodiments, the text recognition engine 204 uses OCR to detect the presence of text.

The text recognition engine 204 is trained on a dataset that includes images with annotated text regions, to help the model learn to recognize text in various orientations and angles. The text recognition engine 204 is language agnostic and works on any text in different languages.

The text recognition engine 204 performs text extraction 520. For example, if the phrase “I love p*rn” where the asterisk is replaced with an “o” is on the skin of a 3D avatar 505, the 2D thumbnail images 510 may include a first 2D thumbnail image 510 of a front-angled avatar where the text appears slightly warped, a second 2D thumbnail image 510 of the avatar directly facing the camera, and a third 2D thumbnail image 510 of the avatar from the opposite front-angled avatar (i.e., rotated at a 45 degree angle from the first 2D thumbnail image 510) where the text appears slightly warped. The text recognition engine 204 may extract the text by cropping a portion of the image that includes the phrase “I love p*rn” in the three different 2D thumbnail images 510.

The text recognition engine 204 provides the extracted text to the text machine-learning model 255. The text machine-learning model 255 receives the extracted text as input and classifies the extracted text. The text machine-learning model 255 may output a determination of whether the extracted text is abusive and, if so, a category of abuse and/or a severity of abusiveness.

The text machine-learning model 255 may use OCR to perform the classification. In some embodiments, the text machine-learning model 255 is a deep learning machine-learning model that is trained using machine learning models to detect abusive text. Types of deep neural networks include CNNs, deep belief networks, transformer models, generative adversarial networks, Bidirectional Encoder Representations from Transformers (BERT), flow models, recurrent neural networks, and Universal Language Model Fine-tuning (ULMFiT). A deep neural network uses multiple layers to progressively extract higher-level features from the raw input where the input to the layers are different types of features extracted from other modules and the outputs are a determination of whether the text includes abuse or not.

The text machine-learning model 255 converts the extracted text into a machine-readable format. The text machine-learning model 255 performs text classification 525 by classifying the extracted text into predefined categories or labels that predict a violation category if any. The text machine-learning model 255 performs text-based analysis to identify instances of abuse or violation. In some embodiments, the text classification module 375 utilizes OCR to train or fine-tune a dataset that includes examples of abusive and non-abusive text.

In some embodiments, the text machine-learning model 255 uses a text classification system to generate labels for recognized text. For example, “Hello.” is associated with a non-abusive label and “F*ck” is associated with an abusive label. In some embodiments, the abusive label may be further refined into categories, such as bullying, sex, and profanity labels. Other labels may be possible. For example, the abusive labels may be expanded to include bullying and harassment, real-world dangerous activities, discrimination and hate, extortion and blackmail, sexual content, violent content and gore, threats of violence, illegal and regulated, dating and romance, profanity, spam, political content, misleading impersonation or misrepresentation, cheating and exploits, etc. For example, “Dog,” “World”, “Chill” are associated with non-abusive labels; “wh*re” (where “o” is used in place of the asterisk) is associated with the abusive label for sex. The labels are added to a training data set. The labels predict the violation category if any. For example, “f*cked” is associated with the abusive label for profanity and falls under the violation category.

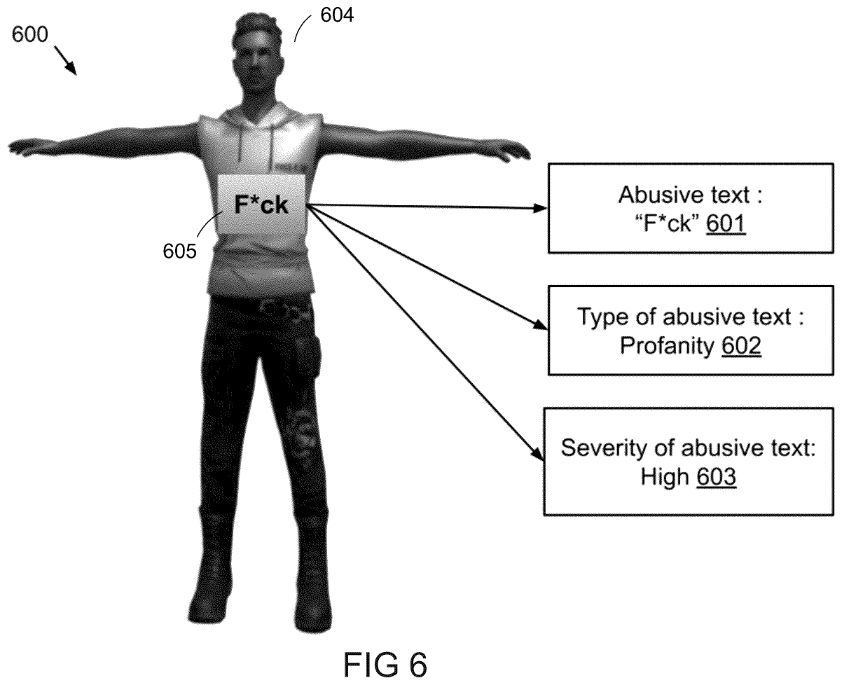

FIG. 6 illustrates an example 600 of a 3D avatar 604 with detected text 605. Although illustrated as “F*ck,” the text in this example includes a “u” instead of the asterisk. The text recognition engine 204 identifies that the 3D avatar 604 includes text 605 and extracts the text 605 from the avatar. The extracted text is provided to the text machine-learning model 255, which outputs a determination of abuse.

In this example, the text machine-learning model 255 determines that the extracted text “F*ck” printed on the t-shirt of the avatar is abusive 601 and is associated with “profanity” as the category of abuse 602. The text machine-learning model 255 further determines that the severity of abusive text “F*ck” is high 603.

In some embodiments, the machine-learning module 206 receives 2D images of a 3D avatar and provides them as input to the shape machine-learning model 260 and/or the outfit machine-learning model 265. In some embodiments, the outfit machine-learning model 265 receives the 2D images if the avatar is wearing clothing and not otherwise. In some embodiments, a user may create a 3D avatar that is approved by the shape machine-learning model 260 and later the user creates costumes for the 3D avatar that are provided to the outfit machine-learning model 265 for approval.

The machine-learning module 206 trains the shape machine-learning model 260 to output a determination that a shape of an avatar is abusive. In some embodiments, the criteria for determining an abusive shape are based on a policy. For example, the policy may include specific examples of shapes that are prohibited, such as shapes that include visible genitals, excessively sized secondary sex characteristics (e.g., enlarged breasts, enlarged butts, an unrealistic hip-to-waist ratio), shapes of non-humanoid creatures that are intended to harass other players (e.g., a figure from a meme that is known to body shame other players or that is associated with a hate group), etc.

In some embodiments, the shape machine-learning model 260 is trained with examples of avatars with shapes that are considered abusive and are labelled as abusive, including a category of abuse. In some embodiments, the shape machine-learning model 260 is updated regularly with new examples of abusive shapes to reflect new trends and/or more subtle distinctions in shapes. For example, the shape machine-learning model 260 may receive training data for fine tuning that are updated with 2D images of avatars that were identified by human moderators as having abusive shapes or where a determination made by the shape machine-learning model 260 was overruled and was determined to not be an abusive shape.

The machine-learning module 206 trains the outfit machine-learning model 265 to output a determination that an outfit of an avatar is abusive. In some embodiments, the criteria for determining an abusive outfit are based on a policy. For example, the policy may include specific examples of outfits that are associated with known hate groups (e.g., a Klu Klux Klan outfit, a Nazi uniform, etc.), outfits that include inappropriate images on them (e.g., an image of figures copulating), etc. In some embodiments, the outfit machine-learning model 265 is trained with examples of avatars that are considered abusive and are labelled as abusive, including a category of abuse.

In some embodiments, the outfit machine-learning model 265 is trained with examples of avatars with outfits that are considered abusive and are labelled as abusive, including a category of abuse. For example, the outfit may be associated with a hate group, the outfit may be too revealing, the outfit may include problematic symbols, etc. In some embodiments, the outfit machine-learning model 265 is updated regularly with new examples of abusive outfits to reflect new trends and/or more subtle distinctions (e.g., a difference between a generic t-shirt and a white nationalist t-shirt). For example, the shape machine-learning model 260 may receive training data that is updated with images of avatars that were identified by human moderators as wearing abusive outfits or where a determination made by the outfit machine-learning model 265 was overruled and was determined to not be an abusive outfit.

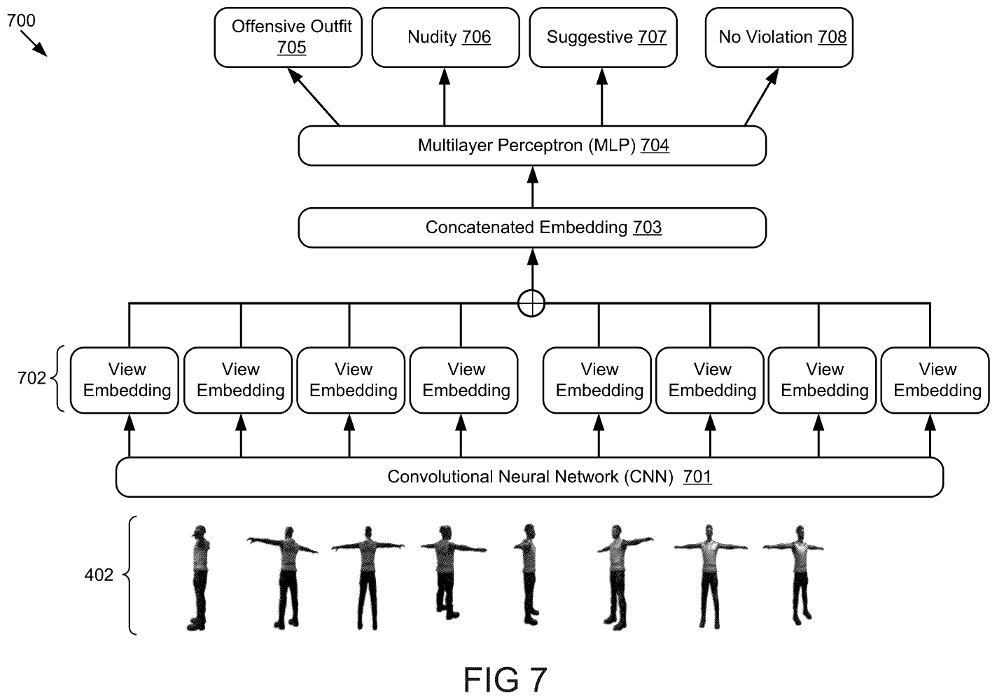

In some embodiments, the shape machine-learning model 260 and/or the outfit machine-learning model 265 use a multiview fusion model. Turning to FIG. 7, a multiview fusion model 700 is illustrated. The multiview fusion model 700 includes multiple machine learning models. Specifically, the multiview fusion model 700 includes a CNN 701 and a MultiLayer Perceptron (MLP) 704.

The CNN 701 receives multiple 2D images 402 (e.g., the 2D images 402 described with reference to FIG. 4) of the 3D avatar from different angles that surround the 3D avatar. The 2D images 402 are high-resolution thumbnails of a 3D avatar, captured using a camera system. In some embodiments, the 2D images 402 are preprocessed to enhance the quality of the image. In some embodiments, during training of the CNN 701, the 2D images 402 may be shuffled and augmented with various random color jittering to train the CNN 701 on greater variation of 2D images 402.

The CNN 701 performs image classification. In some embodiments, the CNN 701 is a residual network with convolutional layers and batch normalization layers. In some embodiments, the CNN 701 includes a series of convolutional layers, batch normalization, activation functions, and residual blocks. The CNN 701 may include one or more convolutional layers that reduce the number of channels in the 2D images 402 for faster processing, one or more convolutional layers that extract spatial details from the reduced 2D images 402, and one or more convolutional layers that restore the reduced 2D images 402 to their original number of channels. In some embodiments, the CNN 701 includes skip connections that add unaltered input direction to the output of the convolutional layers, which advantageously maintains information from earlier convolutional layers. The convolutional layers output a feature map.

In some embodiments, the CNN 701 includes a pooling layer that slides a two-dimensional filter over each channel of the feature map and summarizes the features lying within the region covered by the filter. The pooling layer generates multiple view embeddings 702 of the 2D images 402 where the CNN 701 outputs a view embedding 702 for each of the 2D images 402. The view embeddings 702 provide a compact representation of 2D images that can be used to compare, classify, or detect text across different views or orientations. The multiple view embeddings 702 are concatenated to form a larger multiview embedding 703. The concatenated embedding 703 is provided as input to the MLP 704.

The MLP 704 includes multiple connected neural network layers (e.g., three neural

network layers). The MLP 704 processes the concatenated embedding 703 through non-linear transformations to extract patterns and features. The MLP 704 analyzes an attribute associated with the 3D avatar as described by the concatenated embedding. For example, the MLP 704 may be trained to identify an abusive shape or an abusive outfit.

In some embodiments, the MLP 704 outputs classification results for different categories. For example, the MLP 704 may output a classification of an attribute that matches an offensive outfit category 705, a nudity category 706, a suggestive category 707, or a determination of no violation 708. In some embodiments, the MLP 704 further outputs a severity of the abuse. For example, a shape of a human avatar with breasts that encompass the entire chest may be classified as more severe than a human avatar with smaller breasts. In some embodiments, each determination of an abusive attribute may be associated with a confidence score where the confidence score reflects a confidence in the determination of the abusive attribute.

The abuse module 208 performs a remedial action based on the determination of abuse. For example, the first time a determination of abuse occurs, the remedial action may be a warning and the second time a determination of abuse occurs, the remedial action may be a ban, such as banning customization of the avatar associated with the user that committed the abuse. In some embodiments, the abuse module 208 determines the remedial action based on the severity of the abuse and/or based on the user's history of past infractions. In some embodiments, the determination of abuse is associated with a confidence score and customization of the user's avatar is not banned unless the confidence score meets a threshold confidence value.

In some embodiments, the abuse module 208 applies different sets of rules based on the age of the first player. In some embodiments, the rules are different for the following groups: 13-16, 16-18, or over 18 years old. For example, if a first user is 18 or over, the consequences for the first user committing abuse may escalate faster than if the first user was a minor, i.e., below 18 years old.

In some embodiments, the abuse module 208 may provide the warning to the first user the first time that the abuse module 208 determines that the user is committing abuse before imposing a remedial action.

### Example User Interface

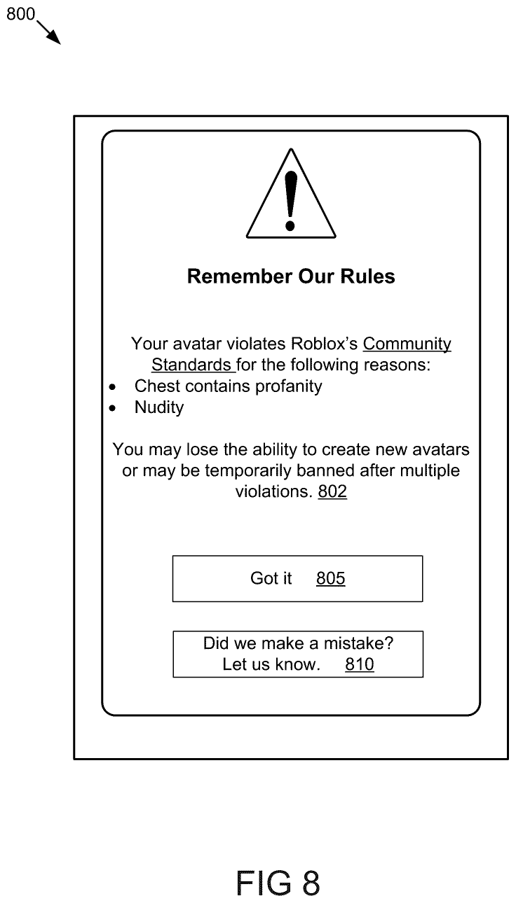

FIG. 8 includes an example user interface 800 that warns a user that a 3D avatar violates community standards. The user interface 800 includes reasons that the avatar is abusive 802 (i.e., because the chest contains profanity and nudity) and that continued violations may result in a remedial action. The community standards text is a link to the community standards. Clicking on the link may take the user to a different page with all the community standards.

The user interface 800 also includes an acknowledgement button 805 indicating that the first user acknowledges the warning. If the user disagrees with the warning, the user may click on the disagreement button 810 with the text “Did we make a mistake? Let us know.” In some embodiments, the abuse module 208 tracks the number of times the user selects the acknowledgement button 805 versus the disagreement button 810.

The remedial action may take several forms and be based on whether the user is associated with previous remedial actions. In some embodiments, the abuse module 208 enacts a temporary ban for initial violations and permanent bans for more severe violations and/or repeat violations. The ban prevents the user engaging with the virtual experience for a period of time. For example, the player ban may include disabling login credentials.

The example user interface 800 may be displayed in response to a user creating an avatar that includes an abusive attribute, in response to a player filing an abuse report triggering a determination that the user created an abusive avatar, in response to an avatar being identified randomly by a moderator, etc.

### Example Methods

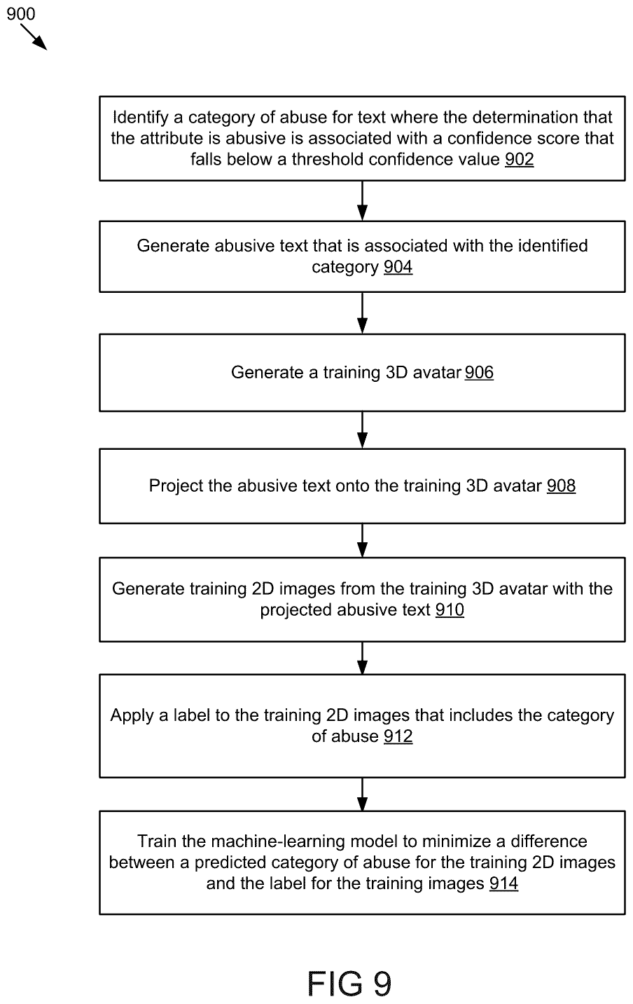

FIG. 9 is a flowchart of an example method 900 to generate synthetic training data for a machine-learning model, according to some embodiments described herein. The method 900 may be performed by the computing device 200 in FIG. 2A.

The method 900 may begin with block 902. At block 902, a category of abuse is identified for text where the determination that the attribute is associated with a confidence score that falls below a threshold confidence value. The category may include profanity, racism, sexism, or bullying. Block 902 may be followed by block 904.

At block 904, abusive text is generated that is associated with the identified category. Block 904 may be followed by block 906.

At block 906, a training 3D avatar is generated. In some embodiments, the training 3D avatar is generated by identifying a 3D avatar in a virtual experience, identifying a 3D mesh of the 3D avatar in a virtual experience, and separating the 3D avatar from the surrounding scene. Block 906 may be followed by block 908.

At block 908, the abusive text is projected onto the training 3D avatar. Block 908 may be followed by block 910.

At block 910, training 2D images are generated from the training 3D avatar with the projected abusive text. In some embodiments, the method 900 further includes shuffling the training 2D images and augmenting the training 2D images with random color jittering. Block 910 may be followed by block 912.

At block 912, a label is applied to the training 2D images that includes the category of abuse. Block 912 may be followed by block 914.

At block 914, the machine-learning model is trained to minimize a difference between a predicted category of abuse for the training 2D images and the label for the training images.

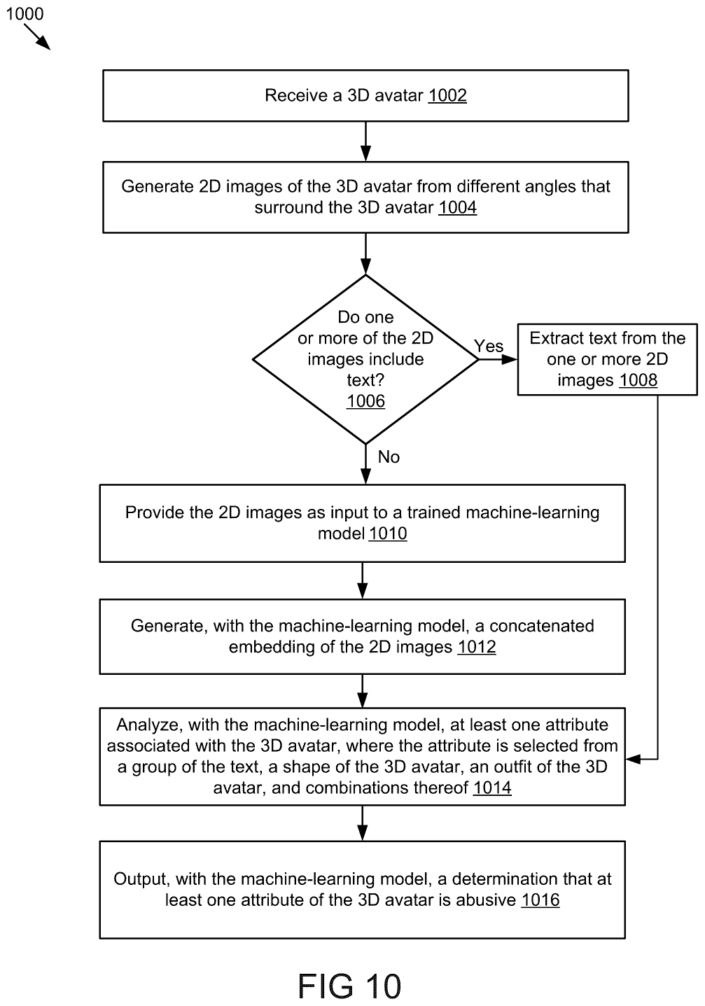

FIG. 10 is a flowchart of an example method 1000 to train a machine-learning model to identify an abusive avatar, according to some embodiments described herein. The method 1000 may be performed by the computing device 200 in FIG. 2A.

The method 1000 may begin with block 1002. At block 1002, a 3D avatar is received. Block 1002 may be followed by block 1004.

At block 1004, 2D images of the 3D avatar are generated from different angles that surround the 3D avatar. Block 1004 may be followed by block 1006.

At block 1006, it is determined whether one or more of the 2D images include text. If one or more of the 2D images include text, block 1006 may be followed by block 1008. If none of the 2D images includes text, block 1006 may be followed by block 1010.

At block 1008, text is extracted from the one or more 2D images. Block 1008 may be followed by block 1014.

At block 1010, the 2D images are provided as input to a trained machine-learning model. Block 1010 may be followed by block 1012.

At block 1012, the machine-learning model generates a concatenated embedding of the 2D images. Block 1012 may be followed by block 1014.

At block 1014, the machine-learning model analyzes at least one attribute associated with the 3D avatar, where the attribute is selected from a group of the text, a shape of the 3D avatar, an outfit of the 3D avatar, and combinations thereof. Block 1014 may be followed by block 1016.

At block 1016, the machine-learning model outputs a determination that at least one attribute of the 3D avatar is abusive.

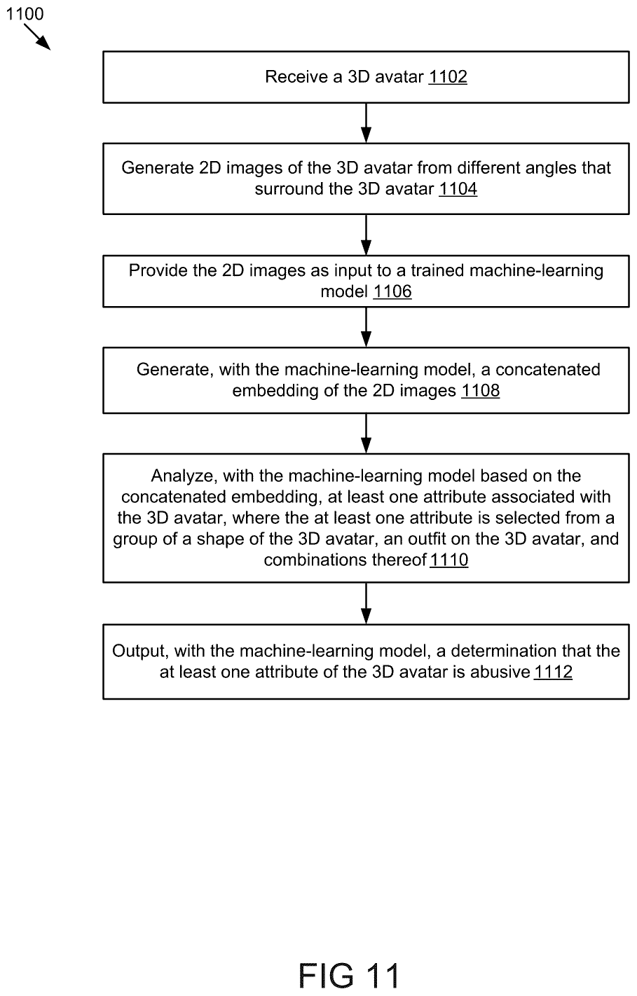

FIG. 11 is a flowchart of an example method 1100 to moderate avatars, according to some embodiments described herein. The method 1100 may be performed by the computing device 200 in FIG. 2A.

At block 1102, a 3D avatar is received. Block 1102 may be followed by block 1104.

At block 1104, 2D images of the 3D avatar are generated from different angles that surround the 3D avatar. In some embodiments, generating the 2D images of the 3D avatar includes capturing high-resolution thumbnails using a virtual camera system. Block 1104 may be followed by block 1106.

At block 1106, the 2D images are provided as input to a trained machine-learning model. Block 1106 may be followed by block 1108.

At block 1108, the machine-learning model generates a concatenated embedding of the 2D images. In some embodiments, the machine-learning model includes a CNN that generates the concatenated embedding by extracting, with a pooling layer, a respective view embedding for each of the 2D images; and concatenating the view embeddings to form the concatenated embedding. Block 1108 may be followed by block 1110.

At block 1110, the machine-learning model analyzes based on the concatenated embedding at least one attribute associated with the 3D avatar, where the at least one attribute is selected from a group of a shape of the 3D avatar, an outfit on the 3D avatar, and combinations thereof. Block 1110 may be followed by block 1112.

At block 1112, the machine-learning model outputs a determination that the at least one attribute of the 3D avatar is abusive. In some embodiments, the 3D avatar is generated by a user and the method 1100 further includes responsive to outputting the determination, providing a notification to the user that the 3D avatar includes the attribute that is abusive and one or more of an identification of a category of abuse, a severity of abusiveness of the attribute, a reason that the attribute is abusive, and combinations thereof. In some embodiments, the method 1100 further includes receiving, from the user, an updated 3D avatar; generating updated 2D images of the updated 3D avatar from different angles that surround the updated 3D avatar; providing the updated 2D images as input to the machine-learning model; outputting, with the machine-learning model, a determination that the attributes are acceptable; and providing the user with an option to use the updated 3D avatar in a virtual environment. In some embodiments, the machine-learning model is trained using training data and the method 1100 further includes responsive to the updated 3D avatar being used in the virtual environment, receiving an abuse report from a player in the virtual environment that describes the updated 3D avatar as having an abusive attribute; determining that the updated 3D avatar has the abusive attribute; and updating the training data associated with the machine-learning model to include the updated 2D images and a label with the category of abuse.

In some embodiments, the method 1100 further includes detecting text on one or more of the 2D images of the 3D avatar; extracting the text from the one or more of the 2D images; and classifying the extracted text to determine if the extracted text is abusive, where the determination that the attribute is abusive is based on classifying the extracted text as abusive. In some embodiments, the machine-learning model is trained using training data and the method 1100 further includes updating the training data associated with the machine-learning model to include training images of attributes that are recently determined to be abusive.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various embodiments. In some embodiments, blocks and operations can be performed multiple times, in a different order, and/or at different times in the methods.

Various embodiments described herein include obtaining data from various sensors in a physical environment, analyzing such data, generating recommendations, and providing user interfaces. Data collection is performed only with specific user permission and in compliance with applicable regulations. The data are stored in compliance with applicable regulations, including anonymizing or otherwise modifying data to protect user privacy. Users are provided clear information about data collection, storage, and use, and are provided options to select the types of data that may be collected, stored, and utilized. Further, users control the devices where the data may be stored (e.g., client device only; client+server device; etc.) and where the data analysis is performed (e.g., client device only; client+server device; etc.). Data is utilized for the specific purposes as described herein. No data is shared with third parties without express user permission.

In the above description, for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the embodiments can be described above primarily with reference to user interfaces and particular hardware. However, the embodiments can apply to any type of computing device that can receive data and commands, and any peripheral devices providing services.

Reference in the specification to “some embodiments” or “some instances” means that a particular feature, structure, or characteristic described in connection with the embodiments or instances can be included in at least one embodiments of the description. The appearances of the phrase “in some embodiments” in various places in the specification are not necessarily all referring to the same embodiments.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic data capable of being stored, transferred, combined, compared, and otherwise manipulated. It has proven convenient at times, principally for reasons of common usage, to refer to these data as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The embodiments of the specification can also relate to a processor for performing one or more steps of the methods described above. The processor may be a special-purpose processor selectively activated or reconfigured by a computer program stored in the computer. Such a computer program may be stored in a non-transitory computer-readable storage medium, including, but not limited to, any type of disk including optical disks, ROMs, CD-ROMs, magnetic disks, RAMs, EPROMs, EEPROMs, magnetic or optical cards, flash memories including USB keys with non-volatile memory, or any type of media suitable for storing electronic instructions, each coupled to a computer system bus.

The specification can take the form of some entirely hardware embodiments, some entirely software embodiments or some embodiments containing both hardware and software elements. In some embodiments, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

What is claimed is:

1. A computer-implemented method comprising:
receiving a three-dimensional (3D) avatar;
generating two-dimensional (2D) images of the 3D avatar from different angles that surround the 3D avatar;
providing the 2D images as input to a trained machine-learning model;
generating, with the machine-learning model, a concatenated embedding of the 2D images;
analyzing, with the machine-learning model based on the concatenated embedding, at least one attribute associated with the 3D avatar, wherein the at least one attribute is selected from a group of a shape of the 3D avatar, an outfit on the 3D avatar, and combinations thereof; and
outputting, with the machine-learning model, a determination that the at least one attribute of the 3D avatar is abusive.

2. The method of claim 1, further comprising:
detecting text on one or more of the 2D images of the 3D avatar;
extracting the text from the one or more of the 2D images; and
classifying the extracted text to determine if the extracted text is abusive, wherein the determination that the attribute is abusive is based on classifying the extracted text as abusive.

3. The method of claim 1, wherein the 3D avatar is generated by a user and the method further comprises responsive to outputting the determination, providing a notification to the user that the 3D avatar includes the attribute that is abusive and one or more of an identification of a category of abuse, a severity of abusiveness of the attribute, a reason that the attribute is abusive, and combinations thereof.

4. The method of claim 3, further comprising:
receiving, from the user, an updated 3D avatar;
generating updated 2D images of the updated 3D avatar from different angles that surround the updated 3D avatar;
providing the updated 2D images as input to the machine-learning model;
outputting, with the machine-learning model, a determination that the attributes are acceptable; and
providing the user with an option to use the updated 3D avatar in a virtual environment.

5. The method of claim 4, wherein the machine-learning model is trained using training data and the method further comprises:
responsive to the updated 3D avatar being used in the virtual environment, receiving an abuse report from a player in the virtual environment that describes the updated 3D avatar as having an abusive attribute;
determining that the updated 3D avatar has the abusive attribute; and
updating the training data associated with the machine-learning model to include the updated 2D images and a label with the category of abuse.

6. The method of claim 1, wherein the machine-learning model includes a Convolutional Neural Network (CNN) that generates the concatenated embedding of the 2D images by:
extracting, with a pooling layer, a respective view embedding for each of the 2D images; and
concatenating the view embeddings to form the concatenated embedding.

7. The method of claim 1, wherein the machine-learning model is trained using synthetic training data for text and the synthetic training data is generated by:
identifying a category of abuse for text where the determination that the attribute is abusive is associated with a confidence score that falls below a threshold confidence value;
generating abusive text that is associated with the identified category;
generating a training 3D avatar;
projecting the abusive text onto the training 3D avatar;
generating training 2D images from the training 3D avatar with the projected abusive text;
applying a label to the training 2D images that includes the category of abuse; and
training the machine-learning model to minimize a difference between a predicted category of abuse for the training 2D images and the label for the training 2D images.

8. The method of claim 7, wherein the synthetic training data is further generated by shuffling the training 2D images and augmenting the training 2D images with random color jittering.

9. The method of claim 1, wherein the machine-learning model is trained using training data and the method further comprises updating the training data associated with the machine-learning model to include training images of attributes that are recently determined to be abusive.

10. The method of claim 1, wherein generating the 2D images of the 3D avatar includes capturing high-resolution thumbnails using a virtual camera system.

11. A non-transitory computer-readable medium with instructions that, when executed by one or more processors at a client device, cause the one or more processors to perform operations, the operations comprising:
receiving a three-dimensional (3D) avatar;
generating two-dimensional (2D) images of the 3D avatar from different angles that surround the 3D avatar;
providing the 2D images as input to a trained machine-learning model;
generating, with the machine-learning model, a concatenated embedding of the 2D images;
analyzing, with the machine-learning model based on the concatenated embedding, at least one attribute associated with the 3D avatar, wherein the at least one attribute is selected from a group of a shape of the 3D avatar, an outfit on the 3D avatar, and combinations thereof; and
outputting, with the machine-learning model, a determination that the at least one attribute of the 3D avatar is abusive.

12. The non-transitory computer-readable medium of claim 11, wherein the operations further include:
detecting text on one or more of the 2D images of the 3D avatar;
extracting the text from the one or more of the 2D images; and
classifying the extracted text to determine if the extracted text is abusive, wherein the determination that the attribute is abusive is based on classifying the extracted text as abusive.

13. The non-transitory computer-readable medium of claim 11, wherein the 3D avatar is generated by a user and the operations further include responsive to outputting the determination, providing a notification to the user that the 3D avatar includes the attribute that is abusive and one or more of an identification of a category of abuse, a severity of abusiveness of the attribute, a reason that the attribute is abusive, and combinations thereof.

14. The non-transitory computer-readable medium of claim 13, wherein the operations further include:
receiving, from the user, an updated 3D avatar;
generating updated 2D images of the updated 3D avatar from different angles that surround the updated 3D avatar;
providing the updated 2D images as input to the machine-learning model;
outputting, with the machine-learning model, a determination that the attributes are acceptable; and
providing the user with an option to use the updated 3D avatar in a virtual environment.

15. The non-transitory computer-readable medium of claim 14, wherein the machine-learning model is trained using training data and the operations further include:
responsive to the updated 3D avatar being used in the virtual environment, receiving an abuse report from a player in the virtual environment that describes the updated 3D avatar as having an abusive attribute;
determining that the updated 3D avatar has the abusive attribute; and
updating the training data associated with the machine-learning model to include the updated 2D images and a label with the category of abuse.

16. A system comprising:
a processor; and
a memory coupled to the processor, with instructions stored thereon that, when executed by the processor, cause the processor to perform operations comprising:
receiving a three-dimensional (3D) avatar;
generating two-dimensional (2D) images of the 3D avatar from different angles that surround the 3D avatar;
providing the 2D images as input to a trained machine-learning model;
generating, with the machine-learning model, a concatenated embedding of the 2D images;
analyzing, with the machine-learning model based on the concatenated embedding, at least one attribute associated with the 3D avatar, wherein the at least one attribute is selected from a group of a shape of the 3D avatar, an outfit on the 3D avatar, and combinations thereof; and
outputting, with the machine-learning model, a determination that the at least one attribute of the 3D avatar is abusive.

17. The system of claim 16, wherein the operations further include:
detecting text on one or more of the 2D images of the 3D avatar;
extracting the text from the one or more of the 2D images; and
classifying the extracted text to determine if the extracted text is abusive, wherein the determination that the attribute is abusive is based on classifying the extracted text as abusive.

18. The system of claim 16, wherein the 3D avatar is generated by a user and the operations further includes responsive to outputting the determination, providing a notification to the user that the 3D avatar includes the attribute that is abusive and one or more of an identification of a category of abuse, a severity of abusiveness of the attribute, a reason that the attribute is abusive, and combinations thereof.

19. The system of claim 18, wherein the operations further include:
receiving, from the user, an updated 3D avatar;
generating updated 2D images of the updated 3D avatar from different angles that surround the updated 3D avatar;
providing the updated 2D images as input to the machine-learning model;
outputting, with the machine-learning model, a determination that the attributes are acceptable; and
providing the user with an option to use the updated 3D avatar in a virtual environment.

20. The system of claim 19, wherein the machine-learning model is trained using training data and the operations further include:
responsive to the updated 3D avatar being used in the virtual environment, receiving an abuse report from a player in the virtual environment that describes the updated 3D avatar as having an abusive attribute;
determining that the updated 3D avatar has the abusive attribute; and
updating the training data associated with the machine-learning model to include the updated 2D images and a label with the category of abuse.
